(19) United States
(12) Patent Application Publication
(10) Pub. No.: US 2004/0199610 A1
(43) Pub. Date: Oct. 7, 2004

(54) Method and arrangement for connecting a workstation to a wide area network

(76) Inventors: Peter Nilson, Linkoping (SE); Elin Albertsson, Jonkoping (SE)

Correspondence Address: BURNS DOANE SWECKER & MATHIS L L P, POST OFFICE BOX 1404, ALEXANDRIA, VA, 22313-1404, US

(21) Appl. No.: 10/474,812

(22) PCT Filed: Apr. 18, 2001
(86) PCT No.: PCT/SE01/00849

(51) Int. Cl. G06F 15/177

(52) U.S. Cl. 709/220

(57) ABSTRACT

The invention describes a means to configure and run diagnostics on a gateway (2), e.g. a modem, network for configuration IP-connectivity (Internet Protocol connectivity) for managing network communication via a local network (LAN) via a gateway (2) to a particular wide area network (3), such as an Ethernet. In routed modes there are different subnets on LAN (Local area network) and WAN (Wide Area Network) side. The invention is also applicable on bridged modes. The gateway (2) is provided with a fixed IP-address. A program is inserted in the workstation adapted to provide settings in the gateway (2) adapted for communication with the particular wide area network (3).

### TECHNICAL AREA

The invention relates to a method and arrangement to connect a workstation through a gateway to a particular wide area network, to which the workstation will be assigned.

### BACKGROUND OF THE INVENTION

There is a problem when connecting a gateway, e.g. a modem to a PC, a MAC or other kind of computer (in the following named workstation) not having IP-connectivity. To configure and run diagnostics on a gateway there must be IP-connectivity to manage the communication between the modem (=gateway) and a workstation. Most of the users are not experienced in configuring a network and this often results in total failure of configuration the gateway, which is crucial.

### SUMMARY OF THE INVENTION

The invention discloses means to configure and run diagnostics on a gateway to configuration IP-connectivity (Internet Protocol connectivity) for establish communication via a local network and a gateway to a particular wide area network, such as an Ethernet.

In routed modes there are different subnets on LAN (Local area network) and WAN (Wide Area Network) side. The invention is also applicable on bridged modes.

### BRIEF DESCRIPTION OF THE DRAWINGS

FIG. 1 shows a first embodiment of network architecture with workstation, modem (gateway), and a particular network, ex. an Ethernet.

FIG. 2 shows a second embodiment of network architecture according to the invention.

In the proceeding the gateway, e.g. an ADSL-modem (ADSL=Asymmetric Digital Subscriber Line) acts as a gateway between a workstation and a particular wide area network.

### DETAILED DESCRIPTION OF PREFERRED EMBODIMENTS

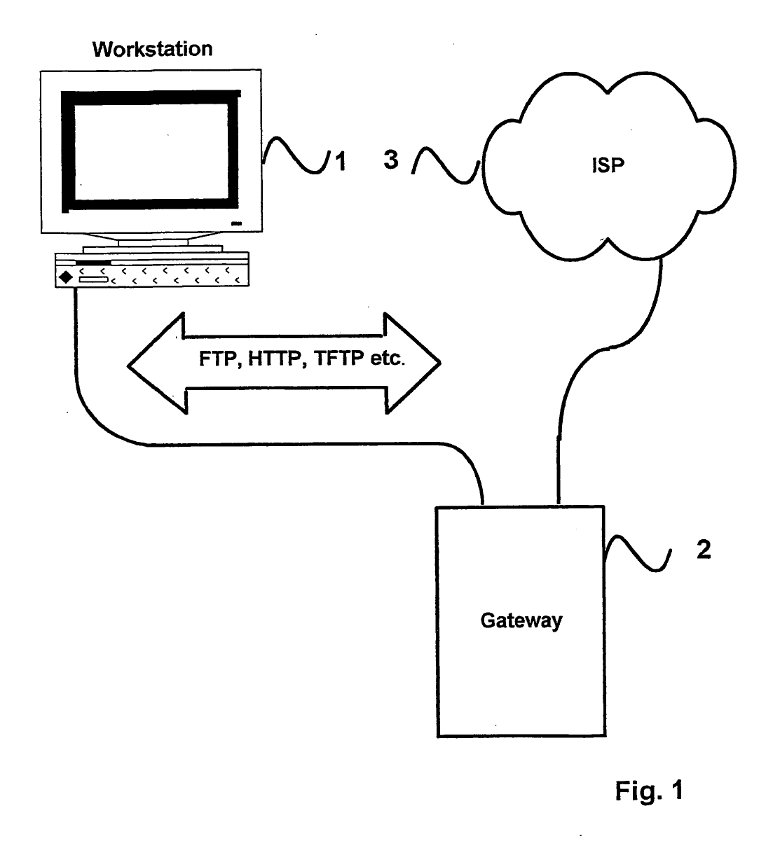

Referring to FIG. 1, a workstation 1, for example a Personal Computer (PC), is connected to a gateway 2, such as a modem, in order to be connected to a particular wide area network 3. The particular wide area network 3 could be anyone of the particular networks providing particular services to clients, which subscribe on their services.

One example of such a network is provided by Tele 2.

The invention provides means to solve the problem when accessing a gateway 2 to a particular wide area network 3 without involving any user interaction. This means that it will be possible to configure the gateway 2 with minimal user disturbances and also retrieve status information from the wide area network 3 via gateway 2, independently of which mode the gateway operates in.

The workstation 1 is provided with an internal software program, which is used only under start and/or configuration procedure, when the local network between the workstation 1 and the gateway 2 is set up. The gateway 2 is provided with a first special fixed IP-address, which is used by the attached workstation 1 for this set up purpose, and a second IP-address (only in routed mode; can be the same as the fixed address), used with a communication with the particular wide area network 3 is established. Thus, after that a start sequence has been established, the upstart procedure is inactive under normal traffic. If some disturbance should occur later on, the same start procedure is restarted by the workstation 1.

Sometimes the manager of the wide area network 3 makes an updating of the communication features of the network. Therewith the wide area network can send information of this updating to the subscribing workstation 1. The workstation 1 then collects a new start program from the wide area network 3.

A start procedure is restarted by the workstation 1 to set up the gateway 2 with new fresh settings.

The software program in the workstation 1 can upgrade the software in the gateway 2 and also fetch status from the gateway 2. Such a procedure could as well be provided automatically without any operation from the user of the workstation 1.

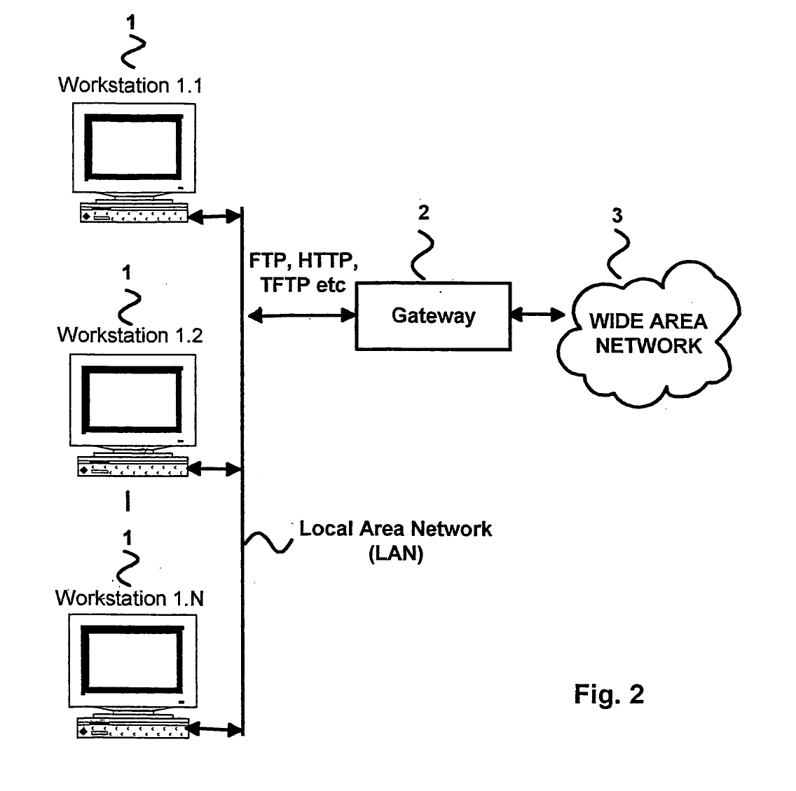

In the second embodiment shown in FIG. 2 more than one workstation (1.1, 1.2, . . . 1.N) in a Local Area Network (LAN) can be attached to the gateway 2. Each of the attached workstations is provided with the actual software program, thus every attached workstation has means to set up the local network to the Gateway 2. After the set up operation is established each of the workstations (1.1, 1.2, . . . 1.N) can communicate with the particular wide area network 3.

Bridged Mode

When running a modem in bridged mode there is no real IP-layer in the modem. The traffic is just on the Ethernet layer.

Even if a gateway modem can be assigned with an IP-number one does not know which network the workstation 1 will be assigned to depends on DHCP server (DHCP=Dynamic Host Configuration Protocol) on ISP side (ISP=Internet Service Provider) or the workstation 1 has a fix address assigned and therefore one cannot assign the modem an address on the same subnet.

The gateway 2 according to the invention has a fixed Special IP-address assigned, that the gateway 2 always responds on, even if it is not on the same subnet With this method an ordinary browser can be used and be connected to the gateway 2 for configuration etc.

The fixed Special number can be used when upgrading the software in the workstation (1) using FTP (=File Transfer Protocol), HTTP (HTTP=Hyper Text Transfer Protocol) and TFTP (TFTP=Trivial File Transfer Protocol). Configuration and software upgrade is only available from local network side, i.e. the workstation 1 or one of the workstations (1.1, 1.2, . . . 1.N).

1. The IP-number normally comes from a DHCP server on the ISP-side. If the gateway 1 (modem) is not configured, connection to the particular wide area network 3 is not working and the workstation 1 (PC) won't get an IP-address. With Hidden IP-connectivity the gateway can be contacted anyway, using the fixed Special IP-number, and then reconfigured to make the particular wide area network 3 connection working.

2. The user does not have to change any settings in the workstation 1 to get in contact with the gateway 2. It also works if the workstation 1 has a fixed IP-address not at all on the subnet as the gateway or the ISP-side.

3. The user does not have to remember the IP-number of the gateway 2.

4. The fixed Special IP-number to use for contacting the gateway 2 is always the same for all gateways of this type. This makes it easier to provide a configuration and manager Tool for the gateway.

Routed Mode

In routed mode there are different subnets on the particular local network (LAN) and the particular wide area network side. Still there can be problems to get the gateway and workstation 1 or 1.1, 1.2, . . . 1.N on the same subnet. The Hidden IP-connectivity solution can be used in this mode too. Benefits with this are described above. Items 2, 3 and 4 are applicable for routed modes.

1. Method to connect a workstation through a gateway to a particular wide area network to which the workstation will be assigned,
characterized by:
providing the gateway with a fix IP-address;
inserting a program in the workstation adapted to provide settings in the gateway adapted for communication with the particular wide area network.

2. Method according to claim 1, characterized by:
when the settings are provided in the gateway, providing normal traffic automatically between the workstation and the particular wide area network.

3. Method according to claim 1, characterized by:
connecting more than one workstation to the gateway, each workstation being assigned to a local network;
providing normal traffic automatically between each workstation and the particular wide area network as soon as one of the workstations has provided the settings in the gateway.

4. Arrangement for connecting a workstation to a particular wide area network to which the workstation will be assigned, characterized by:
a gateway having a fix IP-address to be connected to the workstation;
a program provided in the workstation adapted to make settings in the gateway adapted to the particular wide area network when the workstation has addressed the fix IP-address in the gateway.

5. Arrangement according to claim 4, characterized by:
means in the program to provide normal traffic between the workstation and the particular wide area network after that the settings in the gateway are provided.

6. Arrangement according to claim 4, characterized by:
more than one workstation connected to the gateway, each workstation being assigned to a local network (LAN);
means to provide normal traffic automatically between each workstation and the particular wide area network when the settings in the gateway are provided.

7. Arrangement according to claim 4, characterized in that:
gateways of this type all have the same fixed Special IP-number for communication with the local network.

8. Arrangement according to claim 4, characterized in that:
for updating purposes the particular wide area network is adapted to send an updated program to the workstation(s); that the workstation thereafter resets the setting in the gateway using the updated program.
